(19) United States
(12) Patent Application Publication
(10) Pub. No.: US 2013/0219391 A1
(43) Pub. Date: Aug. 22, 2013

(54) SERVER AND METHOD FOR DEPLOYING VIRTUAL MACHINES IN NETWORK CLUSTER

(71) Applicant: HON HAI PRECISION INDUSTRY CO., LTD., (US)

(72) Inventors: CHUNG-I LEE, New Taipei (TW); CHIEN-FA YEH, New Taipei (TW); CHIU-HUA LU, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/729,072

(22) Filed: Dec. 28, 2012

(30) Foreign Application Priority Data
Feb. 16, 2012 (TW) 101105159

(51) Int. Cl. G06F 9/455

(52) U.S. Cl. CPC G06F 9/45533
USPC 718/1

(57) ABSTRACT

A server for deploying virtual machines (VMs) in a network cluster is provided. The server sets template information for creating VMs, creates a VM based on the template information, receives an IP address assigned to the VM by a dynamic host configuration protocol (DHCP), and deploys the VM into the network cluster. The server then monitors a resource utilization ratio of the network cluster. When the ratio of the network cluster is more than a first preset ratio, the server creates a new VM based on the template information and deploys the new created VM into the network cluster. When the ratio of the network cluster is less than a second preset ratio , the server decreases available resource of the network cluster by suspending or deleting a created VM in the network cluster.

### BACKGROUND

1. Technical Field

Embodiments of the present disclosure relate to virtualization technology, and more particularly to a server and a method for deploying virtual machines in a network cluster.

2. Description of Related Art

Virtual machines (VM) are software implementations that creates one or more VMs in a server. A guest operating system (OS) is a virtualized environment, multiple guest OS can co-exist and run independently on the same server. A network cluster may include one or more servers with VMs, so that resources (e.g., such as CPU resource, hard disk resource) of the network cluster can serve more users. However, if two many VMs are deployed in the network cluster, the resources provided by the network cluster may be superfluous. On another hand, if a small number of VMs are deployed in the network cluster, the resources provided by the network cluster may be insufficient. Therefore, there is a room for improvement in the art.

### BRIEF DESCRIPTION OF THE DRAWINGS

FIG. 1 is a block diagram of one embodiment of a server for deploying VMs in a network cluster.

FIG. 2 is a block diagram of one embodiment illustrating a network environment of a method for deploying VMs in a network cluster.

FIG. 3 is a flowchart of one embodiment of a method for deploying VMs in a network cluster.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

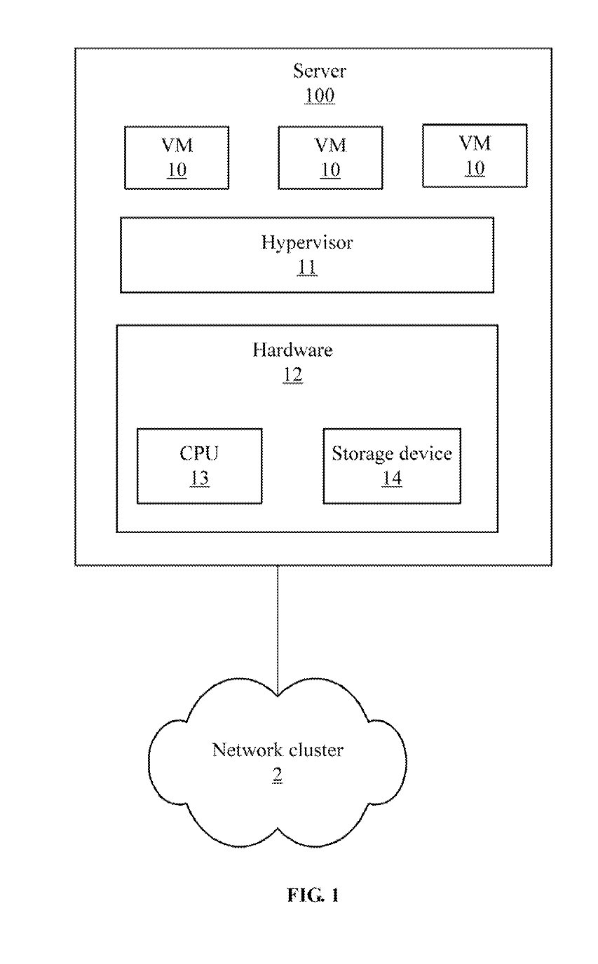

FIG. 1 is a block diagram of one embodiment of a server 100 for deploying virtual machines (VMs) 10 in a network cluster 2. The server 100 includes a hypervisor 11, hardware 12, and one or more VMs 10 created by the hypervisor 11. The hardware 12 includes at least one central processing unit (CPU) 13, and at least one storage device 14. The storage device 14 includes hard disks, and solid-state memory, for example. The hypervisor 11 accesses the hardware 12, and allocates resources (such as CPU resource, hard disk resource, memory resource, and network resource) of the server 100 to create the VMs 10 by executing instructions stored within the at least one storage device 14.

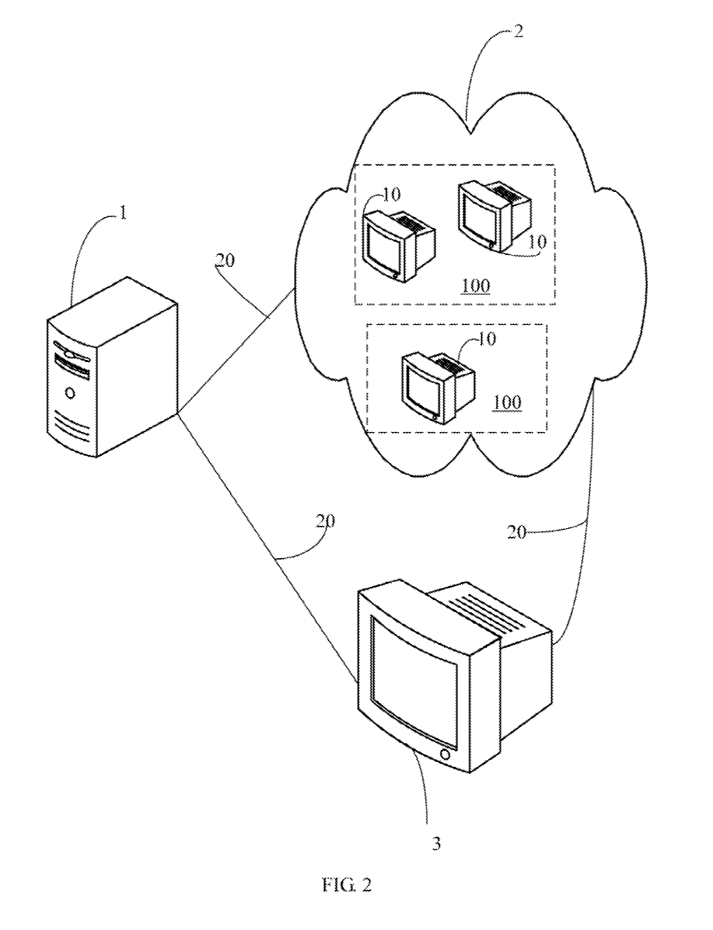

FIG. 2 is a block diagram of one embodiment illustrating a network environment of a method for deploying the VMs 10 in the network cluster 2. A dynamic host configuration protocol (DHCP) server 1 communicates with the network cluster 2 via a network 20. The network 20 may be a wide area network (e.g., the Internet) or a local area network. The network cluster 2 may communicate with other network devices, such as a network server 3, via the network 20. The network server 3 may be a stand-alone server or another network cluster.

In one embodiment, the network cluster 2 includes one or more servers 100, and one or more VMs 10. The one or more VMs 10 may be created by the same server 100 or by different servers 100. For example, in FIG. 2, three VMs are shown, in which two VMs 10 are created by one server 10, and the other VM 10 is created by another server 10. Each of the one or more servers 100 in the network cluster 2 is configured with the hypervisor 11 and the hardware 12 shown in FIG. 1.

The DHCP server 1 is installed with a DHCP service. The DHCP server 1 assigns Internet protocol (IP) addresses to the servers 100 and the VMs 10. A hypervisor 11 of a server 100 monitors a resource utilization ratio of each VM 10. In one embodiment, the resource utilization ratio of the VM 10 includes a utilization ratio of the CPU resource allocated to the VM 10 (hereinafter “a CPU utilization ratio”), a utilization ratio of hard disk resource allocated to the VM 10 (hereinafter “a hard disk utilization ratio”), a utilization ratio of memory resource allocated to the VM 10 (hereinafter “a memory utilization ratio”), and a utilization ratio of network resource allocated to the VM 10 (hereinafter “a network utilization ratio”).

The hypervisor 11 determines a summation resource utilization ratio of the network cluster 2 based on the resource utilization ratios of all the VMs 10 within the network cluster 2. In one embodiment, the summation resource utilization ratio of the network cluster includes a summation of all the CPU utilization ratios (hereinafter, “a summation CPU utilization ratio”), a summation of hard disk utilization ratios (hereinafter, “a summation hard disk utilization ratio”), a summation of memory utilization ratios (hereinafter, “a summation memory utilization ratio”), and a summation of network utilization ratios (hereinafter, “a summation network utilization ratio”) of the network cluster 2. For example, the hypervisor 11 determines the summation CPU utilization ratio relating to the network cluster 2 by totaling the CPU utilization ratio of each VM 10, determines the summation hard disk utilization ratio of the network cluster 2 by totaling the hard disk utilization ratio of each VM 10, determines the summation memory utilization ratio of the network cluster 2 by totaling the memory utilization ratio of each VM 10, and determines the summation network utilization ratio of the network cluster 2 by totaling the network utilization ratio of each VM 10. For example, when there are three VMs 10 in the network cluster 2, if a first VM 10 has a CPU utilization ratio of 50%, a second VM 10 has a CPU utilization ratio of 45%, and a third VM 10 has a CPU utilization ratio of 55%, then a summation CPU utilization ratio of the network cluster 2 is totalized as (50+45+55)/(100+100+100)=50%.

When the hypervisor 11 determines that the summation resource utilization ratio of the network cluster 2 is more than a first preset ratio (such as 85%), the hypervisor 11 increases available resources of the network cluster 2 by creating a new VM 10. Otherwise, if the hypervisor 11 determines that the summation resource utilization ratio of the network cluster 2 is less than a second preset ratio (such as 30%), the hypervisor 11 decreases available resources of the network cluster 2 by deleting or suspending a VM 10 in the network cluster 2. In one embodiment, the hypervisor 11 will create a new VM 10 on condition that any one of the summation CPU utilization ratio, the summation hard disk utilization ratio, the summation memory utilization ratio, and the summation network utilization ratio of the network cluster 2 is more than the first preset ratio, such as the summation CPU utilization ratio of the network cluster is more than 85%. In another embodiment, the hypervisor 11 will create a new VM 10 on condition that each of the aforementioned four ratios is more than the first preset ratio, such as the summation CPU utilization ratio of the network cluster is more than 85%, the summation hard disk utilization ratio of the network cluster is more than 85%, the summation memory utilization ratio of the network cluster is more than 85%, and the summation network utilization ratio of the network cluster is more than 85%.

Similarly, in one embodiment, the hypervisor 11 will delete or suspend a previously-created VM 10 on condition that any one of the summation CPU utilization ratio, the summation hard disk utilization ratio, the summation memory utilization ratio, and the summation network utilization ratio of the network cluster 2 is less than the second preset ratio, such as the summation CPU utilization ratio of the network cluster is less than 30%. In another embodiment, the hypervisor 11 will delete or suspend a created VM 10 on condition that each of the aforementioned four ratios is less than the first preset ratio, such as the summation CPU utilization ratio of the network cluster is less than 30%, the summation hard disk utilization ratio of the network cluster is less than 30%, the summation memory utilization ratio of the network cluster is less than 30%, and the summation network utilization ratio of the network cluster is less than 30%.

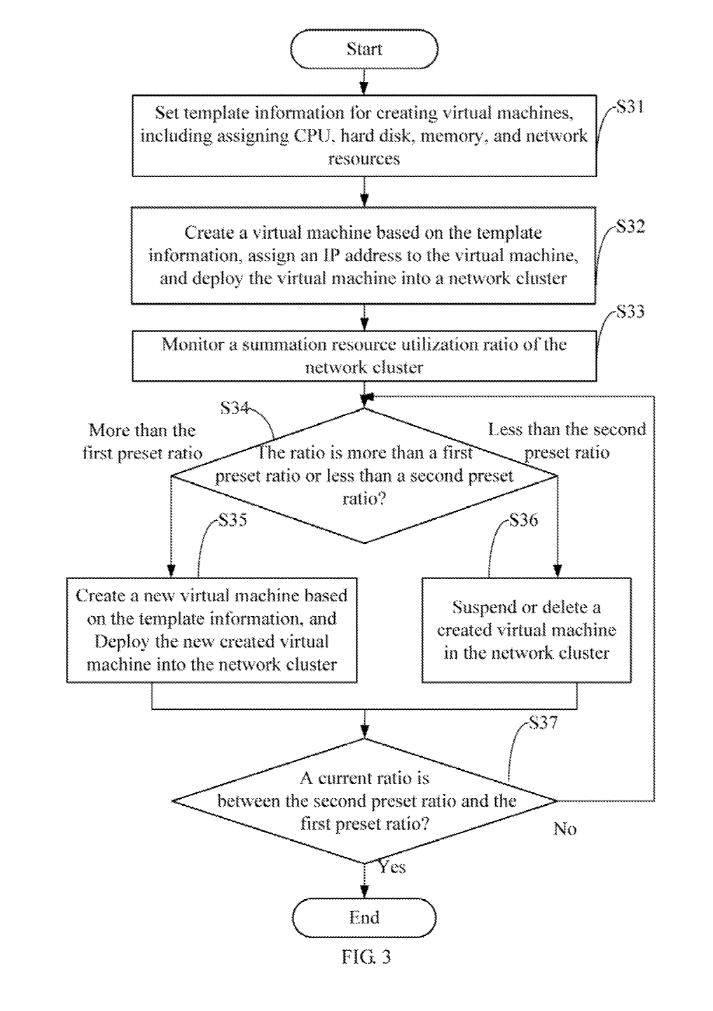

FIG. 3 is a flowchart of one embodiment of a method for deploying VMs 10 in the network cluster 2. Depending on the embodiment, additional steps may be added, others removed, and the ordering of the steps may be changed.

In step S31, the hypervisor 11 in the server 100 sets template information for creating VMs 10, such as assigning memory resource, network resource, CPU resource, and network resource needed for creating the VMs 10. For example, creating a VM 10 with a first type may require one CPU, 2G of memory, and 100G of hard disk space, and creating a VM 10 with a second type may require two CPUs, 4G of memory, and 150G of hard disk space.

In step S32, the hypervisor 11 creates a VM 10 based on the template information, receives an IP address assigned to the VM 10 by the DHCP server 1, and deploys the VM 10 into the network cluster 2. For example, a VM 10 of the first type or of the second type may be created and deployed into the network cluster 2.

In step S33, the hypervisor 11 monitors a summation resource utilization ratio of the network cluster 2 based on the resource utilization ratios of all the VMs 10 in the network cluster 2. As mentioned above, the summation resource utilization ratio of the network cluster includes a summation CPU utilization ratio, a summation hard disk utilization ratio, a summation memory utilization ratio, and a summation network utilization ratio of the network cluster 2. For example, the summation CPU utilization ratio of the network cluster 2 may be determined by totaling the CPU utilization ratio of each VM 10. The summation hard disk utilization ratio of the network cluster 2 may be determined by totaling the hard disk utilization ratio of each VM 10. The summation memory utilization ratio of the network cluster 2 may be determined by totaling the memory utilization ratio of each VM 10. The summation network utilization ratio of the network cluster 2 may be determined by totaling the network utilization ratio of each VM 10.

In step S34, the hypervisor 11 determines if the summation resource utilization ratio of the network cluster 2 is more than a first preset ratio (such as 85%) or less than a second preset ratio (such as 30%). For example, in one embodiment, the hypervisor 11 determines if the summation CPU utilization ratio of the network cluster is more than 85% or less than 30%. If the summation resource utilization ratio of the network cluster 2 is more than the first preset ratio, the hypervisor 11 determines that resources provided by the network cluster 2 are insufficient, and step S35 is implemented. Otherwise, If the summation resource utilization ratio of the network cluster 2 is less than the second preset ratio, the hypervisor 11 determines that resources provided by the network cluster 2 are superfluous, and step S36 is implemented.

In step S35, the hypervisor 11 creates a new VM 10 based on the template information, and deploys the new created VM 10 into the network cluster 2, to increase available resources of the network cluster 2. Then, step S37 is implemented.

In step S36, the hypervisor 11 suspends or deletes a previously-created VM 10 in the network cluster 2, to decrease available resources of the network cluster 2. Then, step S37 is implemented.

In step S37, the hypervisor 11 determines whether a current summation resource utilization ratio of the network cluster 2 is between the second preset ratio and the first preset ratio, such as between 30% and 85%. If the current summation resource utilization ratio of the network cluster 2 remains more than the first preset ratio or remains less than the second preset ratio, the procedure returns to step S34. If the current summation resource utilization ratio of the network cluster 2 is between the second preset ratio and the first preset ratio, such as between 30% and 85%, the procedure ends.

The above embodiments dynamically increase or decrease available resources provided by the network cluster 2 based on the monitoring of resource utilization ratios of the network cluster 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a server for deploying virtual machines (VMs) in a network cluster, the method comprising:
setting template information for creating VMs, comprising assigning resources needed for creating the VMs;
creating a VM based on the template information, receiving an IP address assigned to the VM by a dynamic host configuration protocol (DHCP) server connected to the network cluster via a network, and deploying the VM into the network cluster;
monitoring a summation resource utilization ratio of the network cluster based on resource utilization ratios of all VMs in the network cluster;
increasing available resources of the network cluster by creating a new VM based on the template information and deploying the new created VM into the network cluster, when the summation resource utilization ratio of the network cluster is more than a first preset ratio; and
decreasing available resources of the network cluster by suspending or deleting a previously-created VM in the network cluster, when the summation resource utilization ratio of the network cluster is less than a second preset ratio.

2. The method of claim 1, wherein the resources needed for creating the VMs comprise CPU resource, hard disk resource, memory resource, and network resource.

3. The method of claim 2, wherein the summation resource utilization ratio of the network cluster comprises a summation CPU utilization ratio, a summation hard disk utilization ratio, a summation memory utilization ratio, and a summation network utilization ratio of the network cluster.

4. The method of claim 3, wherein the summation CPU utilization ratio of the network cluster is determined by CPU utilization ratios of each VM in the network cluster, the summation hard disk utilization ratio of the network cluster is determined by totaling hard disk utilization ratios of each VM in the network cluster, the summation memory utilization ratio of the network cluster is determined by totaling memory utilization ratios of each VM, and the summation network utilization ratio of the network cluster is determined by totaling network utilization ratios of each VM in the network cluster.

5. The method of claim 3, wherein the new VM is created on condition that any one selected from the group consisting of the summation CPU utilization ratio, the summation hard disk utilization ratio, the summation memory utilization ratio, and the summation network utilization ratio of the network cluster is more than the first preset ratio.

6. The method of claim 3, wherein the new VM is created on condition that each of the summation CPU utilization ratio, the summation hard disk utilization ratio, the summation memory utilization ratio, and the summation network utilization ratio of the network cluster is more than the first preset ratio.

7. The method of claim 1, wherein the VMs in the network cluster run in the same server or different server.

8. A server, comprising:
at least one CPU;
at least one storage device, which comprises random access memory and one or more hard disks;
a hypervisor that executes instructions stored within the at least one storage device to:
set template information for creating virtual machines (VMs), comprising assigning resources needed for creating the VMs;
create a VM based on the template information, receive an IP address assigned to the VM by a dynamic host configuration protocol (DHCP) server connected to the server via a network, and deploy the VM into a network cluster;
monitor a summation resource utilization ratio of the network cluster based on resource utilization ratios of all VMs in the network cluster;
increase available resources of the network cluster by creating a new VM based on the template information and deploying the newly created VM into the network cluster, when the summation resource utilization ratio of the network cluster is more than a first preset ratio; and
decrease available resources of the network cluster by suspending or deleting a previously-created VM in the network cluster, when the summation resource utilization ratio of the network cluster is less than a second preset ratio.

9. The server of claim 8, wherein the resources needed for creating the VMs comprise CPU resource, hard disk resource, memory resource, and network resource.

10. The server of claim 9, wherein the summation resource utilization ratio of the network cluster comprises a summation CPU utilization ratio, a summation hard disk utilization ratio, a summation memory utilization ratio, and a summation network utilization ratio of the network cluster.

11. The server of claim 10, wherein the summation CPU utilization ratio of the network cluster is determined by totaling CPU utilization ratios of each VM in the network cluster, the summation hard disk utilization ratio of the network cluster is determined by totaling hard disk utilization ratios of each VM in the network cluster, the summation memory utilization ratio of the network cluster is determined by totaling memory utilization ratios of each VM, and the summation network utilization ratio of the network cluster is determined by totaling network utilization ratios of each VM in the network cluster.

12. The server of claim 10, wherein the new VM is created on condition that any one selected from the group consisting of the summation CPU utilization ratio, the summation hard disk utilization ratio, the summation memory utilization ratio, and the summation network utilization ratio of the network cluster is more than the first preset ratio.

13. The server of claim 10, wherein the new VM is created on condition that each of the summation CPU utilization ratio, the summation hard disk utilization ratio, the summation memory utilization ratio, and the summation network utilization ratio of the network cluster is more than the first preset ratio.

14. The server of claim 8, wherein the VMs in the network cluster run in the same server or different server.

15. A non-transitory computer-readable medium having stored thereon instructions that, when executed by a processor of a server, causing the server to perform a method for deploying virtual machines (VMs) in a network cluster, the method comprising:
setting template information for creating VMs, comprising assigning resources needed for creating the VMs;
creating a VM based on the template information, receiving an IP address assigned to the VM by a dynamic host configuration protocol (DHCP) server connected to the network cluster via a network, and deploying the VM into the network cluster;
monitoring a summation resource utilization ratio of the network cluster based on resource utilization ratios of all VMs in the network cluster;
increasing available resources of the network cluster by creating a new VM based on the template information and deploying the new created VM into the network cluster, when the summation resource utilization ratio of the network cluster is more than a first preset ratio; and
decreasing available resources of the network cluster by suspending or deleting a previously-created VM in the network cluster, when the summation resource utilization ratio of the network cluster is less than a second preset ratio.

16. The medium of claim 15, wherein the resources needed for creating the VMs comprise CPU resource, hard disk resource, memory resource, and network resource.

17. The medium of claim 16, wherein the summation resource utilization ratio of the network cluster comprises a summation CPU utilization ratio, a summation hard disk utilization ratio, a summation memory utilization ratio, and a summation network utilization ratio of the network cluster.

18. The medium of claim 17, wherein the summation CPU utilization ratio of the network cluster is determined by totaling CPU utilization ratios of each VM in the network cluster, the summation hard disk utilization ratio of the network cluster is determined by totaling hard disk utilization ratios of each VM in the network cluster, the summation memory utilization ratio of the network cluster is determined by totaling memory utilization ratios of each VM, and the summation network utilization ratio of the network cluster is determined by totaling network utilization ratios of each VM in the network cluster.

19. The medium of claim 17, wherein the new VM is created on condition that any one selected from the group consisting of the summation CPU utilization ratio, the summation hard disk utilization ratio, the summation memory utilization ratio, and the summation network utilization ratio of the network cluster is more than the first preset ratio.

20. The medium of claim 17, wherein the new VM is created on condition that each of the summation CPU utilization ratio, the summation hard disk utilization ratio, the summation memory utilization ratio, and the summation network utilization ratio of the network cluster is more than the first preset ratio.
